(19) United States
(12) Patent Application Publication
(10) Pub. No.: US 2024/0125288 A1
(43) Pub. Date: Apr. 18, 2024

(54) ROCKET PROPULSION SYSTEM

(71) Applicant: Protolaunch Ltd, Cambridge (GB)

(72) Inventors: Matthew ESCOTT, Whitley Bay Tyne and Wear (GB); Matthew COATES, Surrey (GB); Jack COGHEN-BREWSTER, Cambridge (GB)

(73) Assignee: Protolaunch Ltd, Cambridge (GB)

(21) Appl. No.: 18/278,463

(22) PCT Filed: Feb. 22, 2022
(86) PCT No.: PCT/GB2022/050484

§ 371 Date: Aug. 23, 2023

(30) Foreign Application Priority Data
Feb. 23, 2021 (GB) 2102545.7

(51) Int. Cl. F02K 9/50

(52) U.S. Cl. CPC F02K 9/50

(57) ABSTRACT

A rocket propulsion system (200, 300, 400, 500, 600) comprising: a propellant tank (208, 306, 308, 406, 408, 506, 508, 606, 608) arranged to contain propellant, a liquid pressurant tank (202, 302, 402, 502a, 602a) arranged to contain a liquid pressurant and to supply the pressurant to the propellant tank to pressurise the propellant tank, an engine (211, 311, 411, 511, 611), the engine comprising: a combustion chamber (210, 310, 410, 510, 610) arranged to receive pressurised propellant from the propellant tank and defining a volume for combusting the pressurised propellant to produce an exhaust product, and an exhaust nozzle (212, 312, 412, 512, 612) arranged to receive the exhaust product from the combustion chamber, and a heat exchanger (214, 314, 414, 514, 614) arranged to transfer heat from the engine to the pressurant.

### FIELD OF THE INVENTION

This invention relates to a rocket propulsion system, a satellite delivery vehicle and a method of preparing a rocket propulsion system.

### BACKGROUND

Rocket propulsion systems may have several applications, and in particular may be used for transporting payloads, such as satellites, from the surface of the Earth to a high altitude and for providing an increase in velocity in order to accelerate the payload to an orbital velocity.

Existing rocket propulsion systems may involve blowdown cycles, where a pressurised gas is used to pressurise propellants and to move the propellants into a combustion chamber. However, containers for highly pressurised gases may be heavy or expensive.

Turbomachinery may also be used to pressurise a system to drive propellants into an engine. However, turbomachinery may be impractical for smaller systems, such as systems for delivering smaller satellite payloads, as the scaling down of turbomachinery may require parts to move at high speed, leading to manufacturing difficulties.

Further, engines may be cooled by propellants, such as fuels, passing through a cooling jacket on the engine. However, this may result in a pressure loss of the propellant as it passes through the cooling jacket, meaning that the propellant tank must be rated to a higher pressure, providing an associated mass penalty, and the heating of propellants may lead to thermal degradation of the propellant, resulting in coking and other undesirable phenomena.

### SUMMARY OF THE INVENTION

According to a first aspect of the invention, there is provided a rocket propulsion system comprising: a propellant tank arranged to contain propellant; a liquid pressurant tank arranged to contain a liquid pressurant and to supply the pressurant to the propellant tank to pressurise the propellant tank; an engine, the engine comprising: a combustion chamber arranged to receive pressurised propellant from the propellant tank and defining a volume for combusting the pressurised propellant to produce an exhaust product, and an exhaust nozzle arranged to receive the exhaust product from the combustion chamber; and a heat exchanger arranged to transfer heat from the engine to the pressurant.

With such an arrangement, there may be provided a propulsion system having a more optimised mass. This advantage is provided by the pressurant tank being smaller, due to the higher density of liquids as compared to gases, and the pressurant tank being subject to a lower pressure than known blowdown systems, since the pressurant may be stored as a liquid at low pressure, as opposed to being stored as a gas at a high pressure. Generally, systems where a pressurant is stored as a gas may require the gas to be stored at a high pressure in order to achieve a sufficient pressurant density, to avoid the requirement for a high volume pressurant tank. However, the higher density of liquid pressurants remove the necessity for high pressure tanks.

The pressure of the pressurant may be increased as it is heated in the heat exchanger. Consequently, a smaller and lighter system may be provided for efficiently launching smaller payloads, such as nano-satellites and cubesats.

Further, as heat may be extracted from the engine and transferred to the pressurant, as opposed to being transferred to the propellant, a greater variety of propellants may be used as the risk of thermal degradation of the propellants may be reduced.

Still further, this system may require no turbomachinery. Since turbomachinery may be difficult to manufacture and to scale-down, this may improve manufacturability, in particular for propulsion systems for delivering smaller payloads.

The heat exchanger may be a cooling jacket disposed around the combustion chamber and/or the nozzle. A cooling jacket may provide a readily available and efficient means for extracting heat from the engine without disrupting the fluid flow within the engine.

The heat exchanger may have a fluid pathway for the pressurant and the fluid pathway may have a variable cross section to allow evaporation and/or expansion of the pressurant within the heat exchanger. The cross-sectional area of the pathway may increase from the pressurant tank to the propellant tank. Consequently, the pressurant may be stored as a liquid and may enter the propellant tanks as a gas and, in the case that the pressurant evaporates within the heat exchanger, energy removal from the engine may be improved by the latent heat of vaporisation of the pressurant.

The pressurant tank may comprise a vent valve for releasing pressurant from the system. This may allow a liquid pressurant to evaporate within the tank, such as due to boiling of the pressurant, without the pressure in the pressurant tank increasing so as to cause damage to the tank. The boiling or evaporation of the pressurant within the pressurant tank may occur due to heat absorbed from the atmosphere or due to heat transferred to the pressurant by a heat exchanger.

The vent valve may be arranged to maintain the pressure in the pressurant tank below a gauge pressure of 33 bar. It will be understood that a gauge pressure is a pressure difference between the pressure within the tank and atmospheric pressure outside the tank. By maintaining the pressure below 33 bar, the pressurant tank may be made lighter due to lower structural requirements. Generally, the vent valve may be arranged to maintain the pressure in the pressurant tank below the critical pressure of the pressurant. For liquid nitrogen, the critical pressure is an absolute pressure of 34 bar, a gauge pressure of 33 bar at ground level.

The heat exchanger may be a first heat exchanger, optionally an engine cooling jacket, and the rocket propulsion system may further comprise a second heat exchanger arranged to transfer heat to the pressurant in the pressurant tank. The first heat exchanger may transfer heat to the pressurant after it has left the liquid pressurant tank, before it is introduced to the propellant tank, from the engine. The second heat exchanger may transfer heat from pressurant which has been heated in the first heat exchanger to pressurant within the pressurant tank. The second heat exchanger may thereby maintain a sufficiently high pressure within the pressurant tank while the pressurant level within the pressurant tank is depleted by boiling off liquid pressurant in the pressurant tank.

The nozzle may be a first nozzle, the rocket propulsion system may further comprise a second nozzle, and the second nozzle may be arranged to receive pressurant from the second heat exchanger and to exhaust pressurant to the environment. As the amount of pressurant required for cooling of the engine may be greater than the amount of pressurant required for pressurising the propellant tank, excess pressurant may be exhausted to the environment. The second nozzle may make use of the excess pressurant by providing a thrust for the rocket propulsion system.

The pressurant flow to the second nozzle may be controllable to provide vehicle directional control. The rocket propulsion system may thereby provide a steering function without requiring a dedicated propulsion system for driving the steering.

Consequently, the rocket propulsion system may be made more efficient overall.

The rocket propulsion system may further comprise a vapour tank arranged to contain gaseous pressurant formed by evaporation of the liquid pressurant in the liquid pressurant tank and the vapour tank may be arranged to supply pressurant to the first heat exchanger. By separating the gaseous and liquid pressurants into separate tanks, improved control of the pressure within the pressurant tanks may be provided and heat transfer from the second heat exchanger, where the second heat exchanger is present, may be reduced so that the excess pressurant may maintain a higher temperature and thus a velocity from the second nozzle may be increased.

The pressurant tank may contain a liquid at a temperature below 100 Kelvin. By using such a cold liquid, the yield stress of the material in the tank may be increased, meaning that a lighter rocket propulsion system may be provided.

Further, the cooled liquid may be denser than a gaseous pressurant and may be evapourated more easily. For this reason, a liquid having a boiling point below 100 Kelvin at atmospheric pressure may be desirable as a pressurant.

The liquid in the pressurant tank may be liquid nitrogen or liquid helium. It is noted that any inert liquid, or liquid which forms an inert gas, may be used.

The propellant tank may be a first propellant tank arranged to contain a fuel, and the rocket propulsion system may further comprise a second propellant tank arranged to contain an oxidiser, and the first and second propellant tanks may both be pressurised by the pressurant. In this way, a single pressurant may be used to pressurise a dual fuel propellant system.

The first propellant tank may contain ethanol, liquid methane, kerosene, propane, or monomethyl hydrazine. However, other fuels may also be used.

The second propellant tank may contain liquid oxygen, nitrous oxide, hydrogen peroxide or dinitrogen tetroxide. Generally, any oxidising agent may be used.

The rocket propulsion system may further comprise a propellant heat exchanger arranged to transfer heat from the engine to the propellant. The propellant heat exchanger may be arranged to receive propellant from the propellant tank, optionally a fuel tank, and arranged to supply heated propellant to the engine. By providing a propellant heat exchanger, the engine may be cooled by both of the pressurant and the propellant, meaning that a smaller mass of pressurant may be required, which may reduce the overall mass of the rocket propulsion system. The propellant heat exchanger and the first-mentioned heat exchanger may be combined to form an engine cooling jacket having a plurality of channels arranged such that the pressurant flows through a portion of the channels and the propellant flows through a portion of the channels.

The nozzle may be a convergent-divergent nozzle. This may allow the exhaust product to be accelerated to supersonic speed.

The rocket propulsion system may have no active cooling of the pressurant. The pressurant may therefore be cooled before it is introduced into the pressurant tank and no refrigeration system for the pressurant needs to be provided within the rocket propulsion system, meaning that a lighter rocket propulsion system may be provided.

According to a second aspect of the invention, there is provided a satellite delivery vehicle arranged to transport a payload, comprising a rocket propulsion system according to the first aspect.

According to a third aspect of the invention, there is provided a method of preparing the rocket propulsion system of the first aspect, the method comprising: cooling a gas to form a liquid pressurant, and introducing the liquid pressurant into the pressurant tank. By cooling a gas to form a liquid pressurant before introducing the liquid pressurant into the pressurant tank, the requirement for a refrigeration system within the rocket propulsion system may be removed.

### BRIEF DESCRIPTION OF THE DRAWINGS

FIG. 1 is a schematic drawing of a known satellite delivery vehicle;

FIG. 2 shows a known rocket propulsion system;

FIG. 3 shows a rocket propulsion system according to the invention;

FIG. 4 shows a second rocket propulsion system according to the invention;

FIG. 5 shows a third rocket propulsion system according to the invention;

FIG. 6 shows a fourth rocket propulsion system according to the invention; and

FIG. 7 shows a fifth rocket propulsion system according to the invention.

### DETAILED DESCRIPTION

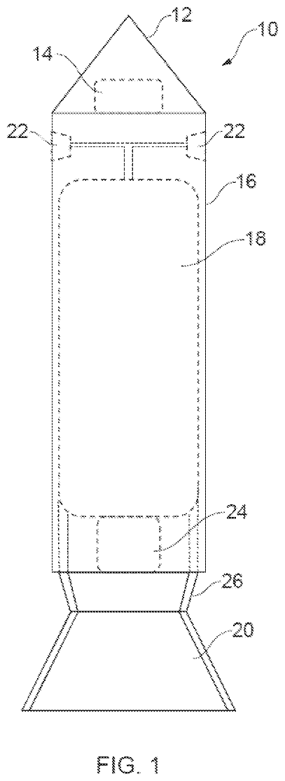

FIG. 1 shows a satellite delivery vehicle 10, which may contain a payload 14, which may be a satellite, such as a small sat, and may weigh less than 500 kg. The payload 14 may be covered by a nose cone or faring 12 arranged to reduce the drag of the vehicle and to protect the payload 14. The satellite delivery vehicle 10 also has a body 16, containing a propulsion system comprising a fuel delivery system 18, a combustion chamber 24 and a nozzle 20.

The vehicle 10 may also have side thrusters 22, which may be nozzles or vents arranged to impart a sideways thrust to the vehicle 10 in order to steer the vehicle 10. The steering nozzles 22 may be powered by the propulsion system or may have their own dedicated propulsion system.

The combustion chamber 24 and nozzle 20 may collectively be referred to as an engine and the vehicle may also comprise a cooling jacket 26, which may be arranged to cool the nozzle 20 and/or the combustion chamber 24 to prevent damage to the engine due to overheating. The cooling jacket 26 may be connected to the fuel delivery system 18 so that components of the fuel delivery system 18 may be heated as the engine is cooled so that the heat energy extracted from the engine may be recycled and a more efficient system may be produced.

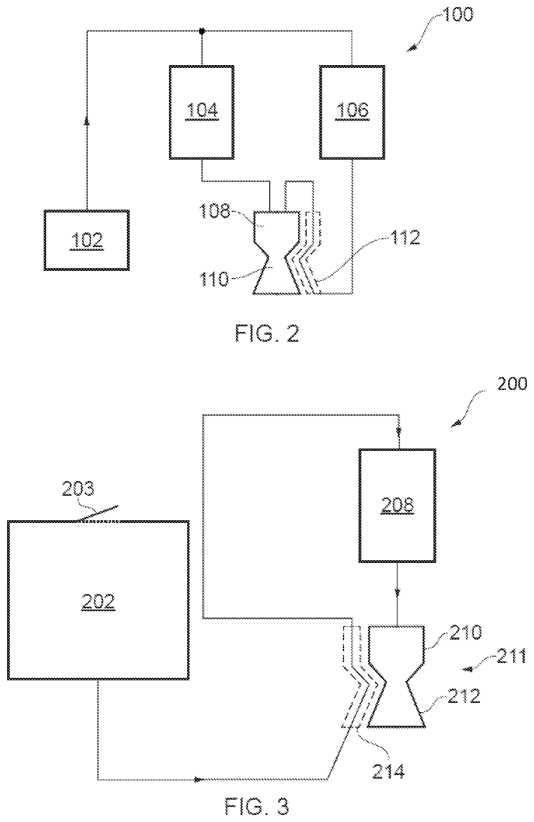

FIG. 2 shows a known gas blowdown propulsion system 100, which may be incorporated within a satellite launch vehicle such as the vehicle 10 shown in FIG. 1. In the system 100, a gas pressurant is stored in a pressurant tank 102, which may be at a high pressure, such as 150 Bar, and the high pressure pressurant may be released from the pressurant tank 102 to pressurise the propellants in the propellant tanks 104 and 106 such that the propellants are driven into the engine, comprising a combustion chamber 108 and a nozzle 110. The propellants may be a fuel and oxidiser system, with a first propellant tank 104 containing an oxidiser and a second propellant tank 106 containing a fuel.

The fuel may, after leaving the propellant tank 106, pass through a cooling jacket 112 before entering the combustion chamber 108. While the fuel 106 is warmed in the cooling jacket 112, it may thermally degrade and may result in coking, where carbon leaves the fuel and deposits on an interior surface of the nozzle cooling jacket 112. This possible thermal degradation places restrictions on the type of fuel which may be used and the amount of cooling which may be provided by the cooling jacket 112.

Further, there may be a pressure drop over the length of the cooling jacket 112, meaning that the fuel in the second propellant tank 106 must be driven at a higher pressure and consequently the pressurant 102 must be stored at a higher pressure. This results in the pressurant tank being heavier and more expensive.

FIG. 3 shows a propulsion system 200 according to the invention which may be used to propel a satellite launch vehicle such as the vehicle 10 shown in FIG. 1. The propulsion system 200 has a liquid pressurant tank 202 containing a liquid pressurant. The pressurant tank 202 will be recognisable as a liquid pressurant tank by the wall thickness, which is arranged to contain a fluid below 33 Bar and the pressurant tank 202 may also have a vent valve 203. The vent valve 203 may be a pressure relief valve and may be arranged to open so as to vent gas to the atmosphere when the pressure inside the pressurant tank 202 exceeds a threshold pressure, and the threshold pressure may be 33 Bar.

It will be understood that the pressurant tank 202 may be filled with a cryogenically cooled liquid, which may be a condensed state of an inert gas, such as liquid helium, liquid nitrogen, or liquid argon. The liquid pressurant may be cooled by an external system before it is introduced into the pressurant tank 202. The pressurant may therefore be introduced to the pressurant tank 202 as a liquid and the propulsion system overall does not require any refrigeration means for cooling the pressurant.

The pressure within the pressurant tank 202 may increase as the temperature of the liquid pressurant rises due to heating by the atmosphere. The pressurant may leave the pressurant tank 202 as a liquid or as a gas and may pass through a heat exchanger 214. Within the heat exchanger, the pressurant may be boiled to produce a vapour or, the pressurant may enter the heat exchanger 214 as a gas and the gaseous pressurant may be heated and may expand and/or increase in pressure. Overall, the pressure of the pressurant may increase as it passes through the heat exchanger 214. While the heat exchanger 214 is shown as a cooling jacket for the engine 211, it will be understood that alternative heat exchangers may be used, such as shell and tube heat exchangers or pipework passing transversely through the nozzle 212. However, cooling jacket heat exchangers are well known and allow heat to be extracted from the engine 211 without disruption of the fluid flow within the engine 211.

Within the heat exchanger 214, the fluid path may have a variable cross section. For example, the fluid path may have an increasing cross section in the direction of fluid flow of the pressurant. The increase in cross section may allow expansion of the pressurant and may provide a pressure increase through the heat exchanger 214.

The heat exchanger 214 may be formed of Aluminium and may be manufactured by additive layer manufacturing. This may allow the cross section of the fluid path to be tailored to provide the desired alteration to the properties of the pressurant as it is heated.

After passing through the heat exchanger 214, the pressurant may be introduced into a propellant tank 208. The propellant tank 208 may contain a monofuel such as nitromethane and the pressure from the pressurant may increase the pressure in the propellant tank 208 and may drive the propellant into the engine 211.

Within the engine 211, the propellant firstly enters a combustion chamber 210, where it ignites and combusts, releasing thermal energy and increasing the temperature and pressure of the gas. This produces one or more exhaust products, which may be carbon dioxide and water vapour, and the exhaust products then pass through a nozzle 212 of the engine 211. When passing through the nozzle 212, the velocity of the exhaust products may increase, to increase the thrust of the propulsion system 200. The nozzle 212 may be a convergent-divergent nozzle in order to accelerate the combustion products to supersonic velocities. In order to avoid heating of the combustion chamber 210 and nozzle 212, which may damage or melt the metal of the engine 211, the cooling jacket 214 may actively cool the engine 211 by extracting thermal heat and transferring the thermal heat to the pressurant as described above.

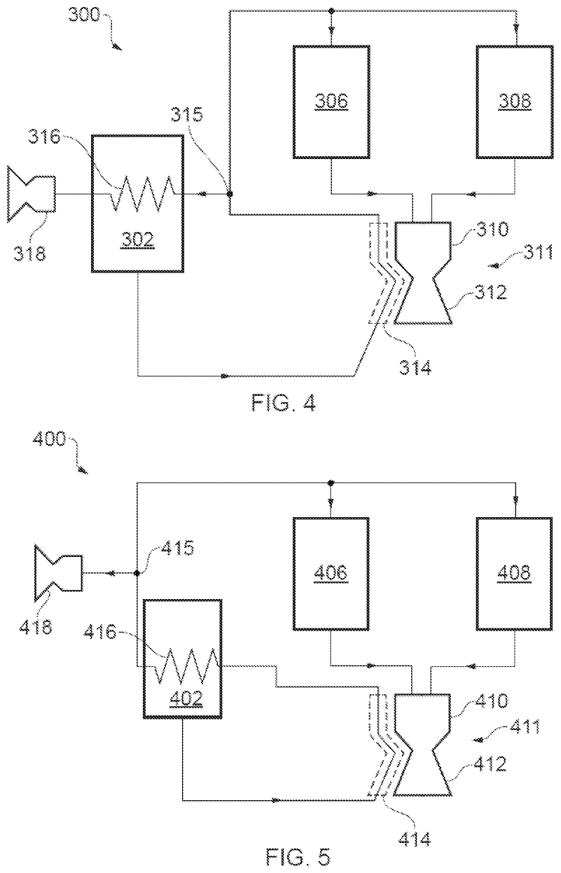

FIG. 4 shows a second rocket propulsion system 300 according to the invention. It will firstly be noted that the engine 311 (comprising the combustion chamber 310 and nozzle 312) and the cooling jacket 314 may be substantially similar to the equivalent parts shown in FIG. 3. The pressurant tank 302 may also be substantially similar to the pressurant tank 202 of FIG. 3, may contain a similar vent valve (not shown), and may be arranged to contain a liquid at a pressure below 33 Bar.

The pressurant tank 302 may, however, further comprise a second heat exchanger 316, which may be referred to as a ‘boil off’ heat exchanger 316. The boil off heat exchanger 316 may have heated pressurant passing therethrough, the heated pressurant having already passed through the nozzle cooling jacket 314. The boil off heat exchanger 316 may act to maintain the pressure within the pressurant tank 302 at a sufficiently high level after the pressurant has been depleted. It will be understood that, during use of the system 300, the volume of liquid pressurant in the pressurant tank 302 may decrease and therefore the pressure in the tank may decrease. The boil off heat exchanger 316 may promote boiling of the liquid pressurant 302, to increase the pressure in the pressurant tank 302 so that a steady pressure in the pressurant tank 302 may be maintained.

The boil off heat exchanger 316 may comprise a plurality of pipes or a coil of pipe within the pressurant tank 302, and the heated pressurant from the first heat exchanger 314 may pass through the pipes of the boil off heat exchanger 316 and may cool as it transfers heat energy to the liquid pressurant in the pressurant tank 302.

After the heated pressurant has passed through the boil off heat exchanger 316 it may pass to a second nozzle 318, which may be a convergent-divergent nozzle or may be a convergent nozzle. The second nozzle 318 may provide directional control to a vehicle or may provide auxiliary thrust. The second nozzle 318 may therefore represent one or both of the two side thruster/steering nozzles 22 shown in FIG. 1.

The system may also comprise a valve 315, which may be operable to control the flow of heated pressurant through the heat exchanger 316 to the second nozzle 318 and to control the flow of pressurant to the propellant tanks 306, 308. The valve 315 may therefore regulate the rate of boil-off of the pressurant within the pressurant tank 302 and/or the pressure within the propellant tanks 306, 308.

The propellant tanks 306, 308 may be a first propellant tank 306 containing a fuel and a second propellant tank 308 containing an oxidiser. In the propulsion system 300, a wide range of fuels and oxidisers may be used, including monofuels, as the fuel may be transferred directly from the propellant tank 306 to the engine 311 without heating and so thermal degradation of the fuel may not be an issue. The fuel and oxidiser may be driven from the propellant tanks 306, 308 into the combustion chamber 310 of the engine 311, combusted, and exhausted through the nozzle 312 as explained above. The fuel and oxidiser may be mixed together by an injector prior to their introduction into the combustion chamber 310. The use of an injector may promote intermixing of the fuel and oxidiser as well as managing their flow rates. This may improve combustion efficiency.

FIG. 5 shows a third rocket propulsion system 400 according to the invention, which is substantially similar to the rocket propulsion systems 200, 300 of FIGS. 3 and 4. The third rocket propulsion system 400 comprises propellant tanks 406, 408, an engine 411 including a combustion chamber 410 and a nozzle 412, heat exchangers 414, 416, a pressurant tank 402 and a second nozzle 418, which may all be substantially similar to those described with reference to FIGS. 3 and 4.

The system 400 differs from the above-described systems in the position of the valve 415. Within the system 400, all of the pressurant from within the pressurant tank 402 may pass through both the first heat exchanger 414 and the second, boil off heat exchanger 416, and consequently the valve 415 may determine whether the pressurant is transferred to the nozzle 418, which may be substantially similar to the nozzle 318 of FIG. 4, or to the propellant tanks 406, 408. With this arrangement, all of the pressurant may pass through the boil off heat exchanger 416, further increasing the pressure in the pressurant tank 402, while maintaining control of the thrust from the second nozzle 418. Consequently, a higher pressure system may be provided, and thermal efficiency may be improved as more heat may be extracted from the heated pressurant in the boil off heat exchanger 416.

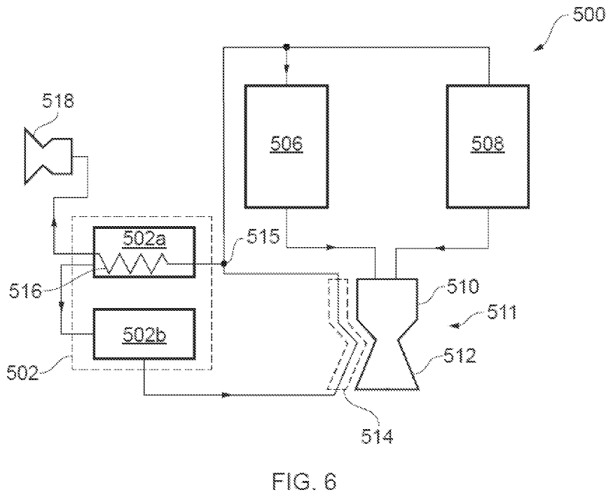

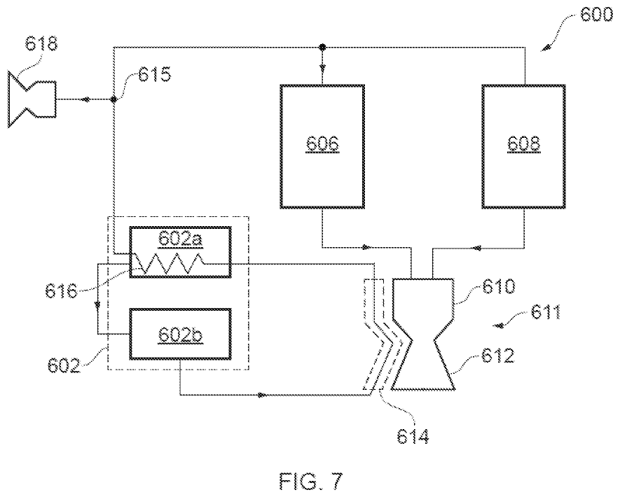

FIG. 6 shows a further rocket propulsion system 500 according to the invention, which is substantially similar to the rocket propulsion systems 300 of FIG. 4. The fourth rocket propulsion system 500 comprises propellant tanks 506, 508, an engine 511 including a combustion chamber 510 and a nozzle 512, heat exchangers 514, 516, a valve 515 and a second nozzle 518, which may all be substantially similar to those described with reference to FIG. 4.

However, in the system 500, the pressurant tank 502 comprises two separate tanks. A liquid pressurant tank 502a may be substantially similar to the pressurant tanks 302, 402 of FIGS. 4 and 5 and on outlet from the liquid pressurant tank 502a is connected to a vapour tank 502b. This arrangement may be beneficial as the smaller volume of material in the liquid pressurant tank 502a may require less heat and therefore the temperature of the pressurant passing through the boil off heat exchanger 516 may be reduced by a lesser amount, meaning that the temperature of the pressurant transferred to the second nozzle 518 may be increased and consequently the velocity of the pressurant from the second nozzle 518 may be increased.

FIG. 7 shows a further rocket propulsion system 600 according to the invention and having aspects of the rocket propulsion systems 400, 500 of FIGS. 5 and 6. In the rocket propulsion system 600, all of the pressurant passes through the boil off heat exchanger 616 within the liquid pressurant tank 602a, and a portion of the pressurant may leave via the second nozzle 618, as is selectable by the valve 615.

Further, the pressurant may have a higher temperature at the exhaust nozzle 618 due to the presence of the vapour pressurant tank 602b, which may reduce the mass of pressurant in the liquid pressurant tank 602a. Consequently, the system 600 may have the benefits of both of the systems 400 and 500.

In a further arrangement, the engine may be cooled by transferring heat to both of the pressurant and the propellant. Such a system comprises a first engine cooling jacket as described above with reference to FIG. 2, which is arranged to receive a propellant, such as a fuel, from a propellant tank, to receive heat from the engine, to transfer the heat to the propellant, and to provide the heated propellant to the engine for combustion.

The system also comprises a second engine cooling jacket as described above with reference to FIGS. 3 to 7, which is arranged to receive a pressurant from a pressurant tank, to receive heat from the engine, to transfer the heat to the pressurant, and to provide the heated pressurant to one or more propellant tanks to pressurise the propellant tanks.

The first and second cooling jackets may be formed as a single, unitary cooling jacket with a plurality of cooling channels. A portion of the cooling channels may be arranged to have pressurant flowing therethrough and a different portion may be arranged to have propellant flowing therethrough.

By using both of a pressurant and a propellant to cool the engine, a smaller quantity of pressurant may be required. This may reduce the overall mass of the engine.

All of the above-described propulsion systems may be controlled by suitable control systems having sensors monitoring temperatures and pressures throughout the system and having valves located throughout the system to control the flow of pressurant, propellants and exhaust gases as appropriate.

Various modifications will be apparent to those in the art and it is desired to include all such modifications as fall within the scope of the accompanying claims.

1. A rocket propulsion system comprising:
a propellant tank arranged to contain a propellant;
a liquid pressurant tank arranged to contain a liquid pressurant and to supply the pressurant to the propellant tank to pressurise the propellant tank;
an engine, the engine comprising:
a combustion chamber arranged to receive pressurised propellant from the propellant tank and defining a volume for combusting the pressurised propellant to produce an exhaust product, and
an exhaust nozzle arranged to receive the exhaust product from the combustion chamber; and
a heat exchanger arranged to transfer heat from the engine to the pressurant.

2. The rocket propulsion system of claim 1, wherein the heat exchanger is a cooling jacket disposed around the combustion chamber and/or the exhaust nozzle.

3. The rocket propulsion system of claim 1, wherein the heat exchanger has a fluid pathway for the pressurant and the fluid pathway has a variable cross sectional area to allow evaporation and/or expansion of the pressurant within the heat exchanger.

4. The rocket propulsion system of claim 1, wherein the liquid pressurant tank comprises a vent valve (203) for releasing pressurant from the system.

5. The rocket propulsion system of claim 4, wherein the vent valve is arranged to maintain the pressure in the liquid pressurant tank below a gauge pressure of 33 bar.

6. The rocket propulsion system of claim 1, wherein the heat exchanger is a first heat exchanger and wherein the rocket propulsion system further comprises a second heat exchanger arranged to transfer heat to the pressurant in the liquid pressurant tank.

7. The rocket propulsion system of claim 6, wherein the second heat exchanger is arranged to transfer heat from pressurant, which has been heated in the first heat exchanger, to pressurant in the liquid pressurant tank.

8. The rocket propulsion system of claim 6, wherein the nozzle is a first nozzle, wherein the rocket propulsion system further comprises a second nozzle, and wherein the second nozzle is arranged to receive pressurant from the second heat exchanger and to exhaust pressurant to the environment.

9. The rocket propulsion system of claim 8, wherein pressurant flow to the second nozzle is controllable to provide vehicle direction control.

10. The rocket propulsion system of claim 1, further comprising a vapour tank arranged to contain gaseous pressurant formed by evaporation of the liquid pressurant in the liquid pressurant tank and arranged to supply pressurant to the heat exchanger.

11. The rocket propulsion system of claim 1, wherein the liquid pressurant tank contains a liquid at a temperature below 100 Kelvin.

12. The rocket propulsion system of claim 11, wherein the liquid is liquid nitrogen or liquid helium.

13. The rocket propulsion system of claim 1, wherein the propellant tank is a first propellant tank arranged to contain a fuel, wherein the rocket propulsion system further comprises a second propellant tank arranged to contain an oxidiser, and wherein the first and the second propellant tanks are both pressurised by the pressurant.

14. The rocket propulsion system of claim 13, wherein the first propellant tank contains liquid ethanol or kerosene.

15. The rocket propulsion system of claim 13, wherein the second propellant tank contains liquid oxygen.

16. The rocket propulsion system of claim 1, further comprising a propellant heat exchanger arranged to transfer heat from the engine to the propellant.

17. The rocket propulsion system of claim 1, wherein the nozzle is a convergent-divergent nozzle.

18. The rocket propulsion system of claim 1, wherein the rocket propulsion system has no active cooling of the pressurant.

19. A satellite delivery vehicle arranged to transport a payload, comprising a rocket propulsion system according to claim 1.

20. A method of preparing the rocket propulsion system of claim 1, the method comprising:
cooling a gas to form a liquid pressurant, and
introducing the liquid pressurant into the liquid pressurant tank.
